(19) United States
(12) Patent Application Publication
(10) Pub. No.: US 2005/0149639 A1
(43) Pub. Date: Jul. 7, 2005

(54) Method, device and system for providing a single user interface to a pluralty of devices

(75) Inventors: Koen Hendrik Johan Vrielink, AA Eindhoven (NL); Bartel Marinus Van De Sluis, Eindhoven (NL); Elmo Marcus Attila Diederiks, Eindhoven (NL); Mark Henricus Verberkt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/504,757

(22) PCT Filed: Jan. 27, 2003
(86) PCT No.: PCT/IB03/00238

(30) Foreign Application Priority Data
Feb. 22, 2002 (EP) 02075726.6

(51) Int. Cl. G06F 3/00

(52) U.S. Cl. 710/8

(57) ABSTRACT

A method (and corresponding system) of providing a single user interface to a plurality of devices (1, 2, 3), where at least a number of the devices comprises at least one user-adjustable parameter (14), the method comprising the steps of transmitting information representing the at least one user-adjustable parameter to a control device (1), obtaining use information regarding a current use of at least a number of the devices, selecting user-adjustable parameters relevant for the current use on the basis of the use information where the parameters are selected from the received parameters, and generating a user interface representation in the control device, where the user interface representation comprises the selected parameters. It is an object of the invention to adapt a single user interface to a plurality of devices and to provide a single remote controller of devices to dynamically adapt to the capabilities of the devices.

This invention relates to a method of providing a single user interface to a plurality of devices, where at least a number of the devices comprise at least one user-adjustable parameter. Additionally, the invention relates to a device for providing a single user interface to a plurality of devices as mentioned.

Further, the invention relates to a system for providing a single user interface to a plurality of devices.

A remote controller for operational control of an apparatus from a remote location is used in connection with video recorders, televisions, security systems etc. Remote controllers that are compatible with a plurality of devices exists, to ease a user from having a multiple of remote controllers in order to control e.g. a television and a VCR simultaneously. Further, it is known from EP0853301, that a remote controller device is able to detect the presence of devices and their capabilities to present a User Interface in accordance with these capabilities. However, the remote controller does not give the user the option of controlling the remote devices in a way that is not supported by the remote devices, e.g. adjusting the sound pan on a single channel radio receiver.

However, this remote controller will give a user the option of adjusting some settings on the remote device, which are not supported by the media being presented by means of said device. That could for instance be adjustment of the colours on a colour television, even if the program being watched is a black/white movie. This will lead to impropriate options presented to the user, which hereby will be seem as inconvenient.

Likewise, it is left for the user to determine if a remote device is useful to present a chosen media stream. That could be a surround sound device connected to the TV. The user has to determine if this surround device is useful in combination with a current program being watched. The TV does not support communication with the surround sound device to perform these tasks automatically, so the remote controller must be adapted to carry out these tasks one by one in sequence. EP0853301 describes a “multi-purpose” device that comprises a user interface for each device separately. The shortcoming of this invention is still, that the user in two steps first will need to switch on one device and second turn off a feature of a second device which doubles one or more of the features of the first device. That could be, that the user would turn on the surround sound device, and second turn off the sound of the TV to get the desired experience.

That is, no user interface is disclosed in the prior art that allows the user to combine such two individual functions with information regarding the current presented media.

It is an object of the invention to provide a method (and corresponding system) that solves the above-mentioned problems of the prior art.

This is achieved by a method (and corresponding system) of providing a single user interface to a plurality of devices, where at least a number of the devices comprises at least one user-adjustable parameter, the method comprising the steps of transmitting information representing the at least one user-adjustable parameter to a control device, obtaining use information regarding a current use of at least a number of the devices, selecting user-adjustable parameters relevant for the current use on the basis of the use information where the parameters are selected from the received parameters, and generating a user interface representation in the control device, where the user interface representation comprises the selected parameters.

In this way, a user interface will be able to present a valid user interface with accessible user-adjustable functions only, e.g. a user interface with selected relevant functions according to the actual accessible media information etc.

That is, it is an object of the invention to adapt a single user interface to a plurality of devices, where at least a number of the devices comprise at least one user-adjustable parameter where the method (and system) solves the problems of the prior art. Additionally, it is an object of the invention to provide a single remote controller of devices to dynamically adapt to the capabilities of the devices.

It is further an object of the invention that a presenting media device provides information regarding the media content being presented.

More specific, it is an object to provide a remote control, which provides an integrated user interface to control a number of devices depending upon a chosen application. This is achieved by querying the available devices that are relevant for a specific application for their control parameters (i.e. when the application is listening to romantic music, the appropriate devices are audio and light, thus those devices are queried for their control parameters). These parameters can then be controlled via an integrated user interface upon the remote control.

In case a media stream such as a movie is being presented on a media device such as a TV screen, and the movie is a black/white production, a colour balance control would be inappropriate and of no use. By querying of the media device by the control device, information regarding the non-colour media stream will be obtained by the control device, which, in the latter described, further will link this information with a received user interface derived from the media device comprising the TV screen, and conclude no need to display the colour balance option.

Other preferred embodiments of the invention are defined in the sub claims.

### BRIEF DESCRIPTION OF THE DRAWINGS

FIG. 1 illustrates an embodiment of the present invention having a control device, a user interface device, and two devices with at least one user-adjustable parameter.

FIG. 2 illustrates a second embodiment of the present invention comprising a user interface device and a control device as a single unit.

FIG. 3a illustrates a schematic block diagram of a user interface device of the present invention.

FIG. 3b illustrates a schematic block diagram of a control device of the present invention.

### DETAILED DESCRIPTION OF EMBODIMENTS

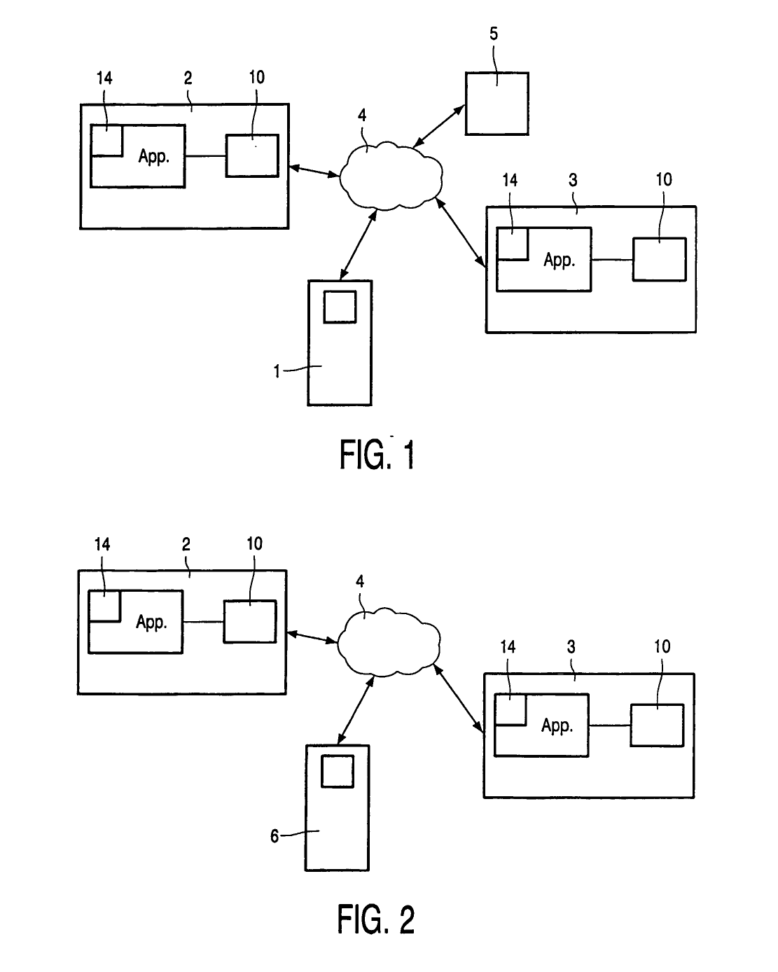

FIG. 1 illustrates an embodiment of the present invention comprising a control device 5, a user interface device 1, and two devices 2, 3 each with an application and an input/output communication interface 10 and at least one user-adjustable parameter. The set of devices 1, 2, 3 and 5 are connected via a wired or wireless (such as Bluetooth or LAN) network 4. At least a number of the devices comprises at least one user-adjustable parameter, where the devices are adapted to transmit information representing the at least one user-adjustable parameter to the control device 5. The control device 5 obtains use information regarding a current use of said number of devices, which typically will be the general capabilities of the said devices such as audio and video capabilities. The control device 5 will select user-adjustable parameters relevant for the current use on the basis of the use information such as currently chosen active devices and by them delivered services. The control device 5 generates a user interface representation comprising said parameters relevant for the current use.

At start-up the control device 5 will do a network request and search for compatible devices with at least one user-adjustable parameter in the current environment and query them for a representation of their user interface and application capabilities. In this way the control device 5 gets an overview of the available capabilities of the identified devices and may determine the best possible user interface to control of these. This optimal user interface may comprise the capabilities of some or all identified application devices. For the application devices in the discussed environment this means, that they must be able to expose their user interface and application capabilities to other devices on the network.

In the following the devices 1, 2, 3 and 5 shown in FIG. 1 will be known as user interface device, TV device, surround sound device and control device respectively.

For example, if the TV 2 is identified in the given environment, it will be prompted to transmit its user accessible interface (e.g. volume and brightness control) and supported media presenting capabilities and other individual capabilities of the current device containing information such as whether the device is able to receive control information and user interface from external control devices. The media presenting capabilities could be information such as the presence of a video screen and loudspeakers for sound. Likewise, the user interface device 1 and a surround sound device 3 will be queried for its user accessible interfaces and media presenting capabilities, after which the devices transmits information about themselves to the control device 5 along with a representation of said user interfaces. Upon receiving this information from the devices, the user interface device 1, the TV 2 and the surround sound device 3, the control device 5 will be able to dynamically generate a user interface comprising a user interface of all devices relevant for the current use. Preferably, the control device may filter out selected doubled functions, so that e.g. a volume button belonging to the TV 2, does not appear to the user concurrent the appearance of the volume button of the surround sound device 3.

After the control device 5 dynamically has derived the combined user interface, the control device 5 may send the combined user interface to the user interface device 1 via the network for presentation to a user.

If, for example, the TV 2 and the surround sound device 3 is represented in an environment, and the control device is started to present a movie, the control device 5 will determine the available contents of the movie based upon information within the movie broadcast. Typically, the TV 2 and the surround sound device 3 may be interconnected with a audio cable or via the network, allowing the audio within the application of the TV 2 to be routed to the surround sound device 3.

If the above-mentioned movie does not contain surround sound information, none of the surround sound settings of the surround sound device 3 should be presented to the user. A typical TV e.g. has an adjustment setting for colour balance, but this option should neither be available to the user, if the media content is identified as a black/white movie.

The user interface of the user-adjustable devices can be queried either as a descriptive user interface only, or more advanced, further as graphical icons by the control device.

As an Example

The TV 2 may e.g. comprise the capabilities of
displaying pictures in colours
presenting audio in stereo
channel selection, and
power on/off

The user interface for the TV 2 would typically then comprise
display related controls such as colour balance and brightness
audio related controls such as volume control and mono/stereo selection
channel selection control, and
on/off control.

By this information, the control device 1 is able to resolve which type of media streams or information the TV 2 can provide, in this specific example picture and audio. The user interface can by the control device 1 be presented to the user as is, as long no other device interferes with identically options. Assuming that a second device, the surround sound device 3, will be introduced to the set of devices in the range of the application.

The surround sound device may for example comprise the capabilities of
presenting surround sound audio
power on/off.

In extension hereof, the user interface of the surround sound device will typically comprise
audio related controls such as volume and treble/bass adjustment, and
on/off control

Now there will be two devices with overlapping features. The volume control exists on both the TV 2 and the surround sound device 3. By defining an optimal experience for the user, it will be determined which device is best suited to present audio. In this case it will be the surround sound device 3, which is to be preferred rather than the sound coming from the TV 2. Therefore, the user interface dynamically designed by the control device 5 will not contain the volume control and other audio related user settings of the TV 2, which are doubled by the surround sound device 3. However, the mono/stereo selection option of the TV 2 could be presented to the user, as this function is still available even though the TV 2 is not the preferred audio device.

Assuming, that a user is watching a movie on the TV display and the audio is directed to the surround sound device for presentation. Next, the user decides to hear all the audio in mono only, that is, by means of the audio capabilities of the TV 2, and selects the appropriate setting on the user interface device 1. The control device 5 will now transmit a command to the TV 2 and set its audio property to mono upon sending a audio routing command to the streaming media device telling that the audio of the presented media now has to be routed to the TV 2. This feature enables the user to experience mono audio without having to consider what to mute and what to unmute.

The on/off options of both devices are exclusive properties of the respective devices, which means, that no other device can double this feature. The on/off option belonging to the TV should still be a part of the dynamical user interface for the given use in parallel to the on/off option of the surround sound receiver.

Likewise, if the movie is not represented in surround sound format, the user interface received from the surround sound device, will accordingly not be presented.

If, for some reason, a user will control the TV 2 volume from a standard remote control (which is not connected to the network), the result would normally be that the internal loudspeaker would be controlled ordinary as a consequence of the user behaviour. Therefore, it is an object that the TV 2 is able to receive control parameters from the control device 5 to gather information of other devices in use.

That is to say, if a surround sound system is used for the audio application, the TV application should be informed not to use internal audio capabilities. In case the TV application receives commands from a non-networked control device, and the application is told not to handle the commands internally, the command should be routed to the surround sound device either directly or via another application on the network capable of receiving user interface information, such as the control device 5.

A device that is not able to receive user interface information from another application can only be used to change user-adjustable parameters that are available for that particular device.

Therefore it is preferred, that the devices in the network are able to expose their user interface capabilities and are able to receive parts of a user interface application, which runs on other devices. However, it may be, that a device may be able to control another device even though it is not able to receive user interface information. In this case, the application is able to send user interface information, which enables it to use other devices in the already contained user interface.

Consider for instance an environment, where there are two TVs, a voice control device and a surround sound device. A user with his user interface device such as a PDA enters this environment and requests by voice to see last weeks Formula 1 race.

The voice control device interprets the command spoken by the user, and starts the Formula 1 application. For the optimal experience, the Formula 1 application now should use the TVs to display the race—one TV per camera angle, put its on-screen controls on the users PDA, the voice control device to receive Formula 1 specific voice commands, and use the surround sound device for the audio, so the Formula 1 application is using the combined and preferred capabilities in the environment to interact with the user.

In above-mentioned example, this means, that the Formula 1 application must look on the network for the devices within the environment. The application will query the devices and find that the TVs provide means to display video, that a user interface device is present and that it is suited to interact with a user via virtual buttons. It will also find the voice control device and the surround sound device. After it has this overview, the Formula 1 application can determine the best possible way to experience the Formula 1 race. It will then via the network connect to the TVs and set them up to display two different camera angles. It will also determine and download a description of the buttons it would like to present to the user based on the received user interfaces of the remote applications. Similarly it sets up the voice control device and surround sound device to implement parts of the Formula 1 applications interaction with the user. So after the control device has gathered information of available devices in the network and dynamically designed the user interface, the control device must send the various parts to the various devices on the network.

If devices are subsequently added the environment, then this will be communicated to the application by the underlying networking system and the application may redesign its user interface and take advantage to the added functionality. Should for instance a second user with a PDA walk into the environment where the Formula 1 application is running, then the Formula 1 application could decide to give also this user control over the application and this way let the controls of the remote devices will be available to the new PDA.

Additionally, if a presented media contains information not deliverable by any device in the environment, the control device can via the user interface device warn the user of this limitation. The control device can moreover deny the user from receiving any of the media information or reduce some of the media contained information, as long as not all required media capabilities are available.

FIG. 2 shows a system, where the control device 5 and user interface device 1 is combined in a single master control device 6, which could be a PDA or similar such as a laptop computer with dedicated software and communication means. By combining the user interface device 1 and the control device 5, there is provided an integrated part, which typically can benefit from portability. Further, a combined portable master control device 6 can contract to a user property with the users preferred settings. In this way, any preferred adjustable device setting can automatically be exported when the user enters a new environment. This could for example be the light intensity or temperature setting in a room.

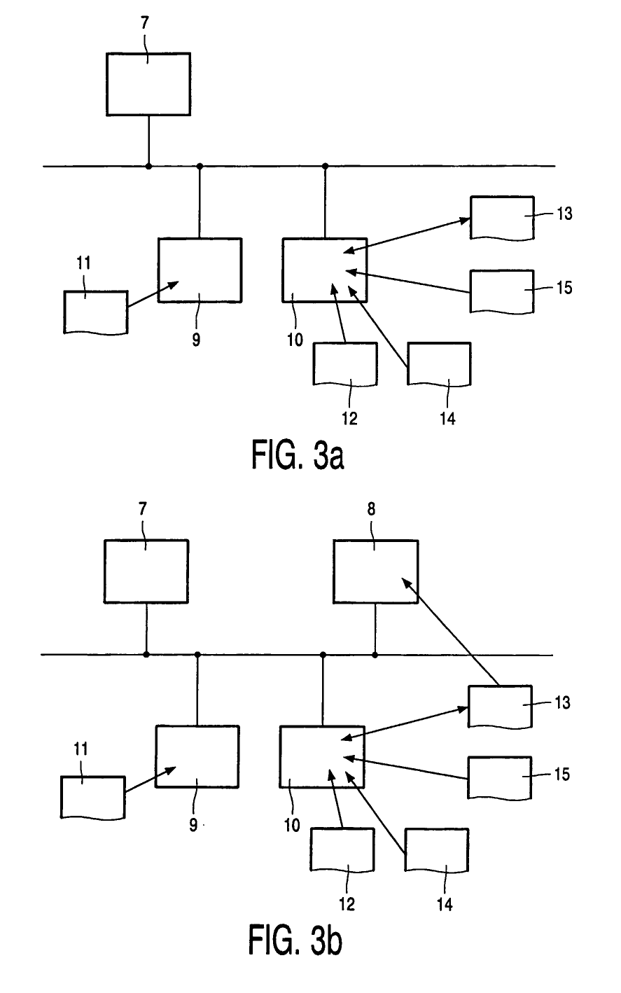

FIG. 3a shows an embodiment of a control device comprising one or more microprocessors 7, a storage 9, and input/output means 10 all connected via a bus according to the present invention. The one or more processors 7 are the interaction mechanism among the storage 9 and the input/output means 10. The input/output means 10 is responsible for communication with the control device 5, wherein a transport of use information 15, user interfaces 12 and other interaction will occur during operation such as available adjustable parameters 14. Profiles 13 regarding a specific user can be uploaded from remote devices via the input/output means 10. This communication between a user interface device and the control device may e.g. be by use of IrDa, Bluetooth, IEEE 802.11, wireless LAN etc. but will also be useful in a wired application solution. The storage 9 stores relevant information like a dedicated computer program 11 for designing a user interface along with received user interface 12 and user profiles 13. The preferred settings may comprehend light settings, surround sound setup and all system related user settings. Further, the storage can comprise program presets to utilize the optimum performance given by any present identified device.

FIG. 3b shows a block diagram of a combined user interface device 1 and control device 5, which is basically an extended control device with a display unit 8 to interact with a user. A user can via the display unit 8 program user profiles 13, control said user interface etc. directly on the combined control device 6.

1. A method of providing a single user interface to a plurality of devices, where at least a number of the devices comprise at least one user-adjustable parameter, the method comprising the steps of:
for at least a number of the devices transmitting information representing the at least one user-adjustable parameter to a control device,
obtaining use information regarding a current use of at least a number of the devices,
selecting user-adjustable parameters relevant for the current use on the basis of the use information, where the parameters are selected from the received parameters, and
generating a user interface representation in the control device, the user interface representation comprising the selected parameters.

2. A method according to claim 1, characterized in that said user interface representation is transmitted to a user interface device, selected among said plurality of devices, for interaction with a user.

3. A method according to claim 2, characterized in that a part of said user interface representation is transmitted to a number of devices selected among plurality of devices.

4. A method according to claim 3, characterized in that the method further comprises the step of:
displaying said user interface representation in said control device for interaction with a user.

5. A method according to claim 4, characterized in that the method further comprises the steps of:
updating the selection of user-adjustable parameters if said use information changes substantially, and
generating an updated user interface representation.

6. A method according to claim 5, characterized in that the user interface interacts by means of a graphical user interface.

7. A system for providing a single user interface to a plurality of devices, where at least a number of the devices comprises at least one user-adjustable parameter, the system comprising:
means (10) in at least a number of the devices (1, 2, 3) transmitting information representing the at least one user-adjustable parameter (14) to a control device (5, 6),
means (10) for obtaining use information (15) regarding a current use of at least a number of the devices (1, 2, 3),
means (7) for selecting user-adjustable parameters relevant for the current use on the basis of the use information (15), where the parameters are selected from the received parameters (14), and
means (7) for generating a user interface representation in the control device (5), the user interface representation comprising the selected parameters.

8. A system according to claim 7, characterized in that said user interface representation is transmitted to a user interface device (1), selected among said plurality of devices (1, 2, 3), for interaction with a user.

9. A system according to claim 8, characterized in that a part of said user interface representation is transmitted to a number of devices selected among plurality of devices (1, 2, 3).

10. A system according to claim 9, characterized in that the system further comprises:
means (8) for displaying said user interface representation in said control device (5, 6) for interaction with a user.

11. A system according to claim 10, characterized in that the system further comprises:
means (7) for updating the selection of user-adjustable parameters if said use information (15) changes substantially, and
means (7) for generating an updated user interface representation.

12. A system according to claim 11, characterized in that the user interface interacts by means of a graphical user interface (8).

13. A system according to claim 12, characterized in that the user interface is a handheld device (6).

14. A control device for providing a single user interface from a plurality of user interfaces, the control device comprising:
means (7) for receiving a user-adjustable parameter (14) from a user-adjustable device (1, 2, 3)
means (7) for obtaining use information (15) regarding a current use of said device
means (7) for selecting user-adjustable parameters (14) relevant for the current use on the basis of said use information (15), where the parameters are selected from the received parameters, and
means (7) for generating a user interface representation comprising the selected parameter.

15. A computer program product (11) having instructions for causing one or more processing units (7, 8, 9, 10) to execute the method according to claim 1.

16. A storage device (9) comprising the computer program (11) as claimed in 15.
